(19) United States
(12) Patent Application Publication
(10) Pub. No.: US 2026/0175207 A1
(43) Pub. Date: Jun. 25, 2026

(54) MULTI-PHASE CATALYST SYSTEM FOR SUSTAINABLE REDUCTION OF NITROUS OXIDE EMISSIONS

(71) Applicant: Joel Whitworth, Lenoir, NC (US)

(72) Inventor: Joel Whitworth, Lenoir, NC (US)

(21) Appl. No.: 19/305,693

(22) Filed: Aug. 20, 2025

Related U.S. Application Data
(63) Continuation-in-part of application No. 18/991,411, filed on Dec. 21, 2024, now abandoned.

(51) Int. Cl. B01J 35/00; B01D 53/34; B01D 53/94; B01J 21/04; B01J 21/06; B01J 23/00; B01J 23/78; B01J 23/86; B01J 23/889; B01J 27/224; B01J 35/45; B01J 35/63; B01J 37/02; B01J 37/03; F01N 3/28; F01N 11/00

(52) U.S. Cl. CPC B01J 35/19; B01D 53/343; B01D 53/9427; B01D 53/9495; B01J 21/04; B01J 21/063; B01J 23/005; B01J 23/78; B01J 23/862; B01J 23/8892; B01J 27/224; B01J 35/45; B01J 35/633; B01J 35/635; B01J 37/024; B01J 37/03; F01N 3/2803; F01N 3/2892; F01N 11/002; B01D 2255/2047; B01D 2255/2073; B01D 2255/20738; B01D 2255/20746; B01D 2255/20753; B01D 2255/20761; B01D 2255/20784; B01D 2255/20792; B01D 2255/405; B01D 2255/9025; B01D 2255/9202; B01D 2257/402; B01D 2258/01; F01N 2370/02

(57) ABSTRACT

A multi-phase catalyst structure for reducing nitrous oxide emissions in exhaust streams is disclosed. The structure includes a primary phase with nickel-copper alloy nanoparticles (10-50 nm, Ni: Cu ratio 3:1 to 4:1) supported on modified alumina (150-200 m²/g) and a manganese oxide promoter; a secondary phase with iron-chromium oxide spinel particles supported on silicon carbide (0.6-0.8 cm³/g) and a zinc oxide modifier; and a tertiary phase with copper-cobalt mixed oxides supported on titanium dioxide (2-50 nm pore size) and a magnesium oxide stabilizer. Interface regions optimize gas flow and phase interactions, while a distributed pore structure facilitates efficient gas diffusion. The system achieves at least 90% nitrous oxide reduction efficiency under optimal conditions using sustainable materials. Additionally, apparatuses for exhaust gas flow optimization and thermal management are disclosed, featuring smart flow architectures, uniform heat distribution, emergency cooling channels, and phase-change material chambers for enhanced catalytic performance and durability.

This application is a continuation in part of U.S. patent application Ser. No. 18/991,411, filed Dec. 21, 2024, which is incorporated herein by reference in its entirety.

### BACKGROUND

Catalytic converters are essential components in exhaust systems, designed to reduce harmful emissions from internal combustion engines by converting pollutants into less harmful substances. They play a critical role in mitigating nitrogen oxides (NOx), which are major contributors to air pollution and smog formation. NOx reduction is achieved through catalytic reactions facilitated by materials such as platinum group metals and metal oxides, which promote the conversion of NOx into nitrogen and water.

### SUMMARY

In one embodiment, the disclosure includes a multi-phase catalyst structure for reducing nitrous oxide emissions in an exhaust stream. The catalyst structure comprises a primary phase formed by nickel-copper alloy nanoparticles with a particle size of 10-50 nm and a nickel-to-copper ratio between 3:1 and 4:1, supported on modified alumina having a surface area of 150-200 m²/g, along with a manganese oxide promoter distributed within the primary phase to enhance catalytic activity. A secondary phase comprises iron-chromium oxide spinel particles supported on silicon carbide with a pore volume of 0.6-0.8 cm³/g, and further includes a zinc oxide modifier integrated to improve stability and performance. A tertiary phase comprises copper-cobalt mixed oxides supported on titanium dioxide with a pore size distribution of 2-50 nm and a magnesium oxide stabilizer incorporated to enhance thermal durability. Interface regions between the phases are configured to optimize gas flow and promote phase interactions, while a distributed pore structure featuring micropores and mesopores facilitates efficient gas diffusion and catalytic reactions. The structure is designed to achieve a nitrous oxide reduction efficiency of at least 90% under optimal operating conditions and is constructed from sustainable, readily available materials.

In another embodiment, the disclosure includes an apparatus for optimizing exhaust gas flow in a catalytic converter system. The apparatus comprises a housing defining an interior chamber with an inlet and an outlet, and a smart flow architecture integrated within the housing. This architecture includes a flow distributor at the inlet to evenly spread the incoming exhaust gases, a plurality of optimized flow channels designed to promote turbulence and enhance gas mixing, pressure equalization zones positioned to minimize pressure drop, and turbulence generation zones to increase interaction between the gases and catalytic surfaces. In addition, a flow optimizer at the outlet streamlines gas discharge while maintaining backpressure within acceptable limits. A mounting assembly is operatively connected to the housing to enable universal installation with existing exhaust systems, thereby enhancing the efficiency of catalytic reactions.

In a further embodiment, the disclosure provides a method for managing thermal conditions in a catalytic converter system. The method involves defining an interior chamber within a housing designed to accommodate a catalyst structure and integrating an advanced thermal management system. The thermal management system includes a heat distribution network that ensures uniform temperature across the catalyst, temperature monitoring points for real-time data collection, and emergency cooling channels that activate when temperatures exceed a preset threshold to prevent thermal damage. The method further includes configuring thermal gradient zones to optimize heat transfer, surrounding the housing with multi-layered insulation that incorporates high-temperature refractory material and an outer layer of low thermal conductivity material, and integrating a phase-change material chamber containing a salt hydrate composition (with a melting point between 200° C. and 300° C.) to stabilize temperature fluctuations. The method operates the catalytic converter system within a temperature range of 150° C. to 900° C. to ensure efficient catalytic reactions and prolonged catalyst durability, with additional embodiments employing heat exchanger fins within the distribution network, regions of reduced cross-sectional area to enhance convective heat transfer, and integration of a control unit that dynamically adjusts emergency cooling based on monitored thermal data.

These and other features of the disclosure will be more clearly understood from the following detailed description and accompanying drawings.

### BRIEF DESCRIPTION OF DRAWINGS

FIG. 1 is a cross-sectional system diagram illustrating the overall architecture of the catalytic converter, including the multi-phase catalyst chambers and flow optimization components.

FIG. 2 is a schematic diagram illustrating the multi-phase catalyst structure, including the arrangement of primary, secondary, and tertiary phases with interface regions and distributed pore structures.

FIG. 3 is a schematic diagram illustrating the flow distribution system within the catalytic converter, showcasing optimized gas flow patterns and turbulence generation zones.

FIG. 4 is a schematic diagram illustrating the thermal management system integrated into the catalytic converter housing.

FIG. 5 is a sequential flow chart diagram illustrating the manufacturing process for the multi-phase catalyst structure, including preparation, treatment, application, and integration steps.

FIG. 6 is a schematic diagram illustrating the recycling system components for material recovery and regeneration processes.

FIG. 7 illustrates a detailed representation of nanoparticle structure and distribution within the catalyst phases.

FIG. 8 illustrates a schematic diagram of the integration specifications for the universal mounting system and exhaust system compatibility.

FIG. 9 is a schematic diagram illustrating the performance testing setup for emissions measurement, pressure monitoring, and data collection in the catalytic converter system.

FIG. 10 is a schematic block diagram illustrating the integration of control systems, including pathways, feedback loops, and diagnostic interfaces for managing catalytic converter operations.

### DETAILED DESCRIPTION OF DISCLOSURE

The present detailed description provides illustrative embodiments of the disclosed advancements, which pertain to catalytic converter systems designed to reduce nitrous oxide (N₂O) emissions. These advancements are situated within the broader field of exhaust gas treatment technologies, emphasizing sustainable materials, improved catalytic efficiency, and integrated recycling methodologies. While specific embodiments, configurations, and examples are described herein, these are provided solely for illustrative purposes and are not intended to limit the scope of the disclosed subject matter.

Certain details, such as standard manufacturing techniques, material preparation methods, and common design principles, may be omitted where they are well-known to those skilled in art. Furthermore, the described subject matter allows for various modifications, rearrangements, and alternative implementations that achieve the same or similar objectives, as long as they fall within the scope of the appended claims. The disclosed embodiments are intended to serve as a foundation for understanding the described subject matter, while allowing flexibility for adaptation and optimization in practical applications.

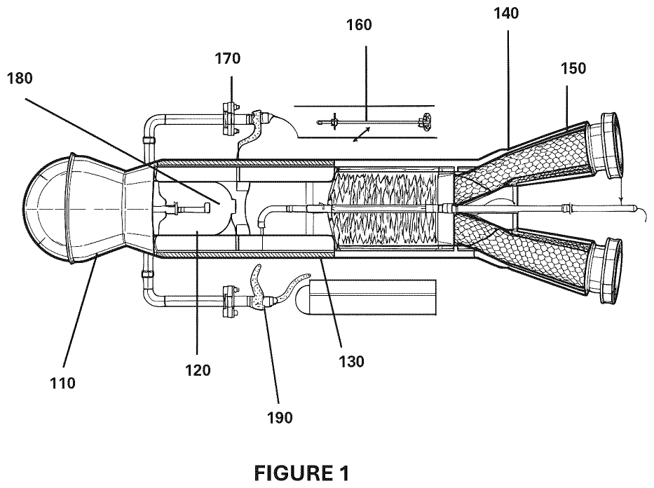

FIG. 1 presents an overview of the catalytic converter system, illustrating the primary components and their arrangement within the broader architecture. This figure provides a cross-sectional view of the system, emphasizing the integration of various chambers, flow optimization features, and monitoring points necessary for effective operation.

The inlet cone with flow distributor 110 is positioned at the entry point of the catalytic converter. This component is designed to evenly distribute incoming exhaust gases across the interior chamber, ensuring uniform flow and minimizing localized pressure variations. The flow distributor is significant in enhancing the interaction between exhaust gases and the catalyst structure downstream.

The primary catalyst chamber 120 is the first phase of the multi-phase catalyst structure. This chamber houses the nickel-copper alloy nanoparticles supported on modified alumina, along with the manganese oxide promoter. The primary catalyst chamber is configured to initiate the reduction of nitrous oxide emissions by facilitating catalytic reactions under controlled conditions.

The secondary catalyst chamber 130 follows the primary chamber and contains iron-chromium oxide spinel particles supported on silicon carbide, along with a zinc oxide modifier. Additionally or alternatively, cordierite or stainless steel may be used to support the iron-chromium oxide spinel particles. This chamber is designed to enhance the stability and performance of the catalytic reactions, further reducing nitrous oxide emissions while maintaining high thermal durability.

The tertiary catalyst chamber 140 represents the concluding phase of the multi-phase catalyst structure. This chamber incorporates copper-cobalt mixed oxides supported on titanium dioxide, along with a magnesium oxide stabilizer. The design of the tertiary chamber prioritizes thermal durability and efficient catalytic activity, facilitating the thorough reduction of nitrous oxide emissions prior to the release of exhaust gases from the system.

The exit cone with flow optimizer 150 is located at the discharge end of the catalytic converter. This component streamlines the exhaust gas flow, maintaining backpressure within acceptable limits while supporting effective gas discharge. The flow optimizer plays an important role in sustaining the overall functionality of the catalytic converter system.

The mounting brackets and housing 160 provide structural support and enable universal installation of the catalytic converter with existing exhaust systems. These components are designed to ensure compatibility with a wide range of vehicle configurations while maintaining the integrity of the system during operation.

Sensor mounting locations 170 are strategically positioned throughout the catalytic converter system to accommodate sensors for monitoring various operational parameters. These sensors collect data related to temperature, pressure, and gas composition, which play a significant role in enhancing the performance of the catalytic reactions.

Temperature monitoring points 180 are integrated within the housing to provide real-time data on the thermal conditions inside the catalytic converter. These monitoring points play an important role in maintaining uniform temperature distribution across the catalyst structure and avoiding thermal damage during operation.

Pressure measurement ports 190 are included to monitor the pressure levels within the catalytic converter system. These ports help detect any pressure drops or irregularities that could impact the efficiency of the catalytic reactions and overall system performance.

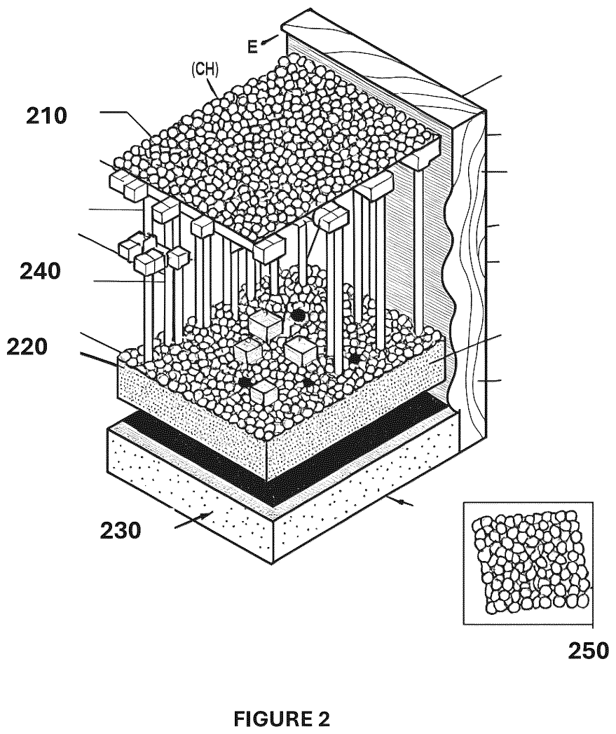

FIG. 2 shows a multi-phase catalyst structure designed to enhance the reduction of nitrous oxide emissions in exhaust streams. The figure illustrates the arrangement of distinct catalyst phases, their interface regions 240, and the distributed pore structure 250 that facilitates efficient gas diffusion and catalytic reactions.

The primary phase layer structure 210 is depicted as the foundational layer of the catalyst system. This phase comprises nickel-copper alloy nanoparticles supported on modified alumina, with a manganese oxide promoter distributed throughout the layer. The nickel-copper alloy nanoparticles are optimized for particle size and composition ratios to maximize catalytic activity, while the modified alumina provides a high surface area to support the dispersion of active sites. The manganese oxide promoter further enhances the catalytic efficiency by increasing the reaction rates for nitrous oxide reduction.

The secondary phase configuration 220 is positioned above the primary phase and consists of iron-chromium oxide spinel particles supported on a silicon carbide framework. This phase incorporates a zinc oxide modifier to improve the stability and performance of the catalytic reactions. The iron-chromium oxide spinel structure is designed to withstand high temperatures and maintain catalytic activity under varying exhaust conditions, while the silicon carbide support provides mechanical durability and thermal conductivity. The zinc oxide modifier contributes to the longevity of the catalyst by mitigating degradation and enhancing the interaction between the active components.

The tertiary phase arrangement 230 constitutes the uppermost layer of the catalyst structure. This phase incorporates copper-cobalt mixed oxides supported on titanium dioxide, with a magnesium oxide stabilizer integrated to improve thermal durability. The copper-cobalt mixed oxides offer active sites for the concluding stages of nitrous oxide reduction, while the titanium dioxide support facilitates uniform distribution of these active sites. The magnesium oxide stabilizer plays a significant role in preserving the structural integrity of the catalyst during extended exposure to elevated temperatures and reactive exhaust gases.

The interface regions between phases 240 are strategically configured to optimize gas flow and promote interaction between the primary, secondary, and tertiary phases. These regions facilitate the transfer of reactants and intermediates between the layers, ensuring that the catalytic reactions proceed efficiently across the entire structure. The design of the interface regions minimizes resistance to gas flow while maximizing the contact area between the phases.

The pore structure and distribution 250 play a significant role in the functionality of the multi-phase catalyst. The distributed pore network includes both micropores and mesopores, which are designed to improve gas diffusion and allow access to active sites within each phase. The pore structure is developed to regulate the flow of exhaust gases while retaining reactants, promoting catalytic reactions under favorable conditions. This distributed pore network also aids in enhancing reduction efficiency by supporting uniform gas distribution and reducing pressure drops within the catalyst structure.

The materials selected for the device were chosen based on their

widespread availability from multiple global suppliers and their common use in industrial applications, ensuring reliability and ease of sourcing. These materials also offer a cost-effective alternative to rare earth elements while maintaining proven stability at high temperatures. Additionally, the existence of established recycling methods supports sustainability and end-of-life management, making them both a practical and environmentally responsible choice.

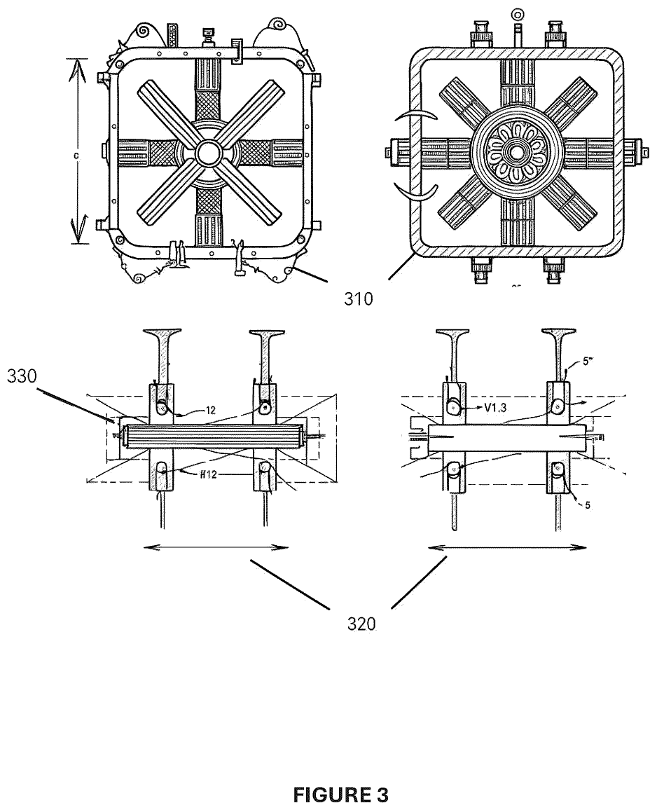

FIG. 3 shows the flow distribution system within the catalytic converter, which is designed to optimize exhaust gas flow and enhance the efficiency of catalytic reactions. The system incorporates several components that collectively regulate gas flow patterns, promote turbulence, and ensure uniform distribution of exhaust gases across the catalytic surfaces.

The mechanical separation mechanisms 620 play a significant role in the system, providing structural support and facilitating the separation of gas streams into distinct flow channels. These mechanisms are configured to direct the exhaust gases into predefined pathways, ensuring that the flow remains consistent and evenly distributed throughout the system. The flow channels may have curved or serpentine geometries.

The gas flow pattern 6D is a significant feature illustrated in FIG. 3, showcasing the primary flow channels and secondary distribution paths. These patterns are designed to promote turbulence within the exhaust stream, thereby increasing the interaction between the gases and the catalytic surfaces. The turbulence generation zones within the flow distribution system contribute to enhancing the catalytic reactions by increasing the contact between the exhaust gases and the active sites of the catalyst structure.

The pressure equalization system, represented by components such as 6D0 and 6S0, is strategically integrated into the flow distribution architecture. This system may include integrated baffles, thereby minimizing pressure drops and ensures uniform gas flow across the catalytic converter. By maintaining consistent pressure levels, the system prevents localized variations that could negatively impact the efficiency of the catalytic reactions.

The mounting assembly components, including 610 and 630, provide structural stability and enable the integration of the flow distribution system within the catalytic converter housing. These components are designed to accommodate various configurations and ensure compatibility with existing exhaust systems. The mounting assembly also supports the alignment of the flow channels, ensuring optimal gas flow through the system.

The component 512 is positioned to regulate the flow dynamics within the system, contributing to the overall optimization of gas distribution. This component works in conjunction with the other elements to streamline the exhaust gas flow and maintain backpressure within acceptable limits.

The system also includes additional features, such as 93 and 9A, which further enhance the functionality of the flow distribution system. These components may be configured to support the structural integrity of the system or to facilitate the interaction between the exhaust gases and the catalytic surfaces.

Overall, FIG. 3 illustrates a sophisticated flow distribution system that integrates mechanical separation mechanisms, optimized gas flow patterns, and a pressure equalization system to enhance the performance of the catalytic converter. The design prioritizes uniform gas distribution, turbulence generation, and pressure regulation, ensuring efficient catalytic reactions and improved reduction of nitrous oxide emissions.

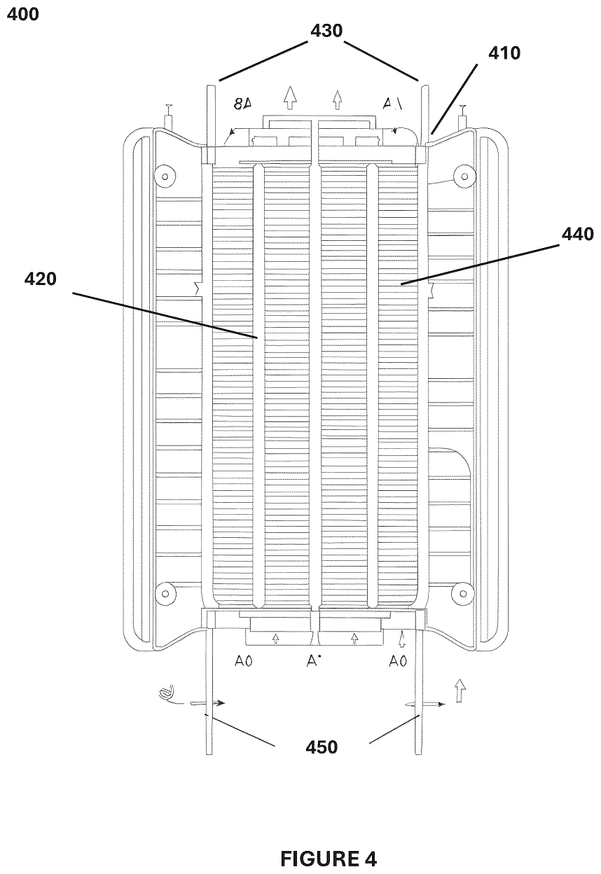

FIG. 4 shows the thermal management system integrated into the catalytic converter housing, which is designed to ensure uniform temperature distribution, prevent thermal damage, and enhance the overall efficiency of catalytic reactions.

The heat distribution network 400 serves as an integral part of the thermal management system. This network is designed to distribute heat uniformly across the catalyst structure, ensuring that all regions maintain appropriate operating temperatures. By reducing temperature gradients that might otherwise result in uneven catalytic activity or localized thermal stress, the network enhances the durability and operational efficiency of the catalyst.

The temperature monitoring points 410 are strategically positioned within the housing to provide real-time data on the thermal conditions inside the catalytic converter. These monitoring points enable precise tracking of temperature variations, allowing for dynamic adjustments to the thermal management system. The data collected from these points plays a significant role in maintaining uniform temperature distribution and preventing overheating or underheating scenarios.

The emergency cooling channels 420 are integrated into the system to activate during overheating conditions. These channels are designed to rapidly dissipate excess heat, protecting the catalyst structure from thermal damage. The cooling channels operate in conjunction with the heat distribution network 400 to stabilize the temperature and ensure the operational range of the system is maintained.

The thermal gradient zones 430 are configured to optimize heat transfer within the catalytic converter. These zones are designed to manage the flow of thermal energy, ensuring that heat is effectively distributed across the catalyst structure while minimizing losses. The thermal gradient zones play a significant role in maintaining the efficiency of catalytic reactions by regulating the temperature profile within the system.

The insulation layers 440 surround the housing to minimize heat loss and improve thermal efficiency. These layers are constructed from materials with high thermal resistance, ensuring that the heat generated within the catalytic converter is retained and utilized effectively. The insulation layers also contribute to the overall energy efficiency of the system by reducing the need for external heating or cooling interventions.

The phase-change material chambers 450 are integrated into the thermal management system to store and release thermal energy as needed. These chambers utilize phase-change materials that absorb heat during high-temperature conditions and release thermal energy during cooler periods, thereby stabilizing temperature fluctuations. This feature enhances the thermal stability of the catalytic converter, ensuring consistent performance under varying exhaust gas conditions.

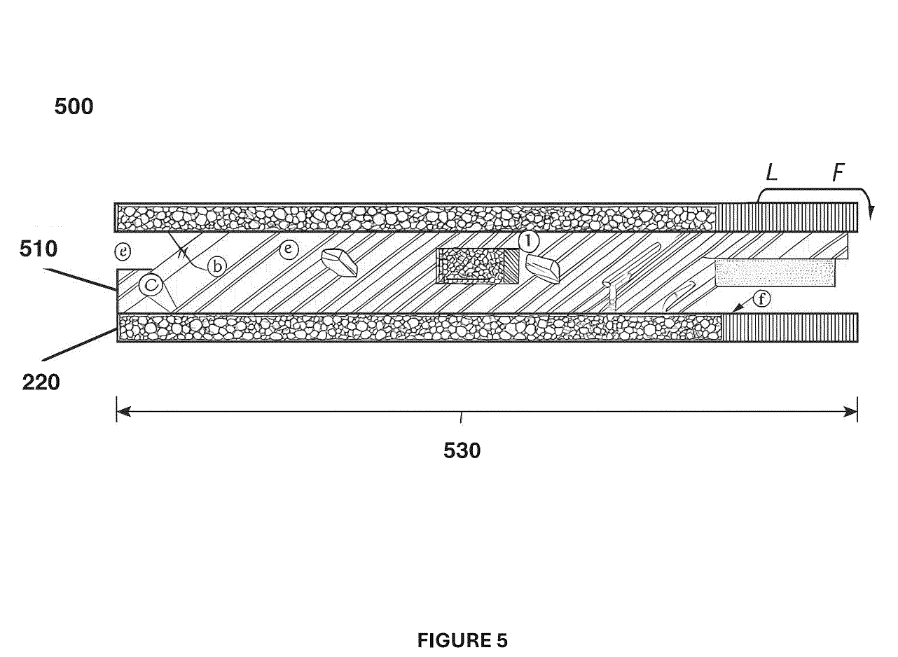

FIG. 5 shows the manufacturing process flow for the multi-phase catalyst structure, detailing the sequential steps involved in the preparation 500, treatment 510, application 520, and integration 530 of the catalyst components.

The catalyst preparation steps 500 represent the initial phase of the manufacturing process. This step involves the synthesis of nickel-copper alloy nanoparticles, iron-chromium oxide spinel particles, and copper-cobalt mixed oxides, which serve as the active components of the multi-phase catalyst structure. The preparation process includes co-precipitation, reduction, and calcination techniques to achieve the desired particle size, composition ratios, and thermal stability. Additionally, precursor solutions are prepared with controlled concentrations and pH levels to ensure uniformity in the resulting catalyst materials.

The support material treatment 510 follows the catalyst preparation phase and focuses on the modification of support materials such as alumina, silicon carbide, and titanium dioxide. This step involves pre-treatment processes, including thermal activation and surface modification, to enhance the surface area, pore volume, and chemical compatibility of the support materials. The treated support materials are designed to provide a stable matrix for the dispersion of active catalyst components and to facilitate efficient gas diffusion during catalytic reactions.

The layer application process 520 constitutes the next phase of the manufacturing flow. In this step, the prepared catalyst materials are applied onto the treated support surfaces in distinct layers corresponding to the primary, secondary, and tertiary phases of the multi-phase catalyst structure. The application process includes techniques such as washcoating, impregnation, and drying to ensure uniform distribution of active sites and promoters within each layer. The layer thickness and adhesion properties are carefully controlled to maintain structural integrity and optimize catalytic performance.

The final integration steps 530 complete the manufacturing process by assembling the multi-phase catalyst structure into the designated housing or chamber. This step involves the alignment and bonding of the catalyst layers, ensuring proper interface regions between the phases to promote interaction and gas flow. Quality control measures are implemented during this phase to verify the uniformity, stability, and functionality of the assembled catalyst structure. The integrated catalyst assembly is then subjected to testing protocols to confirm the nitrous oxide reduction efficiency and durability under operating conditions.

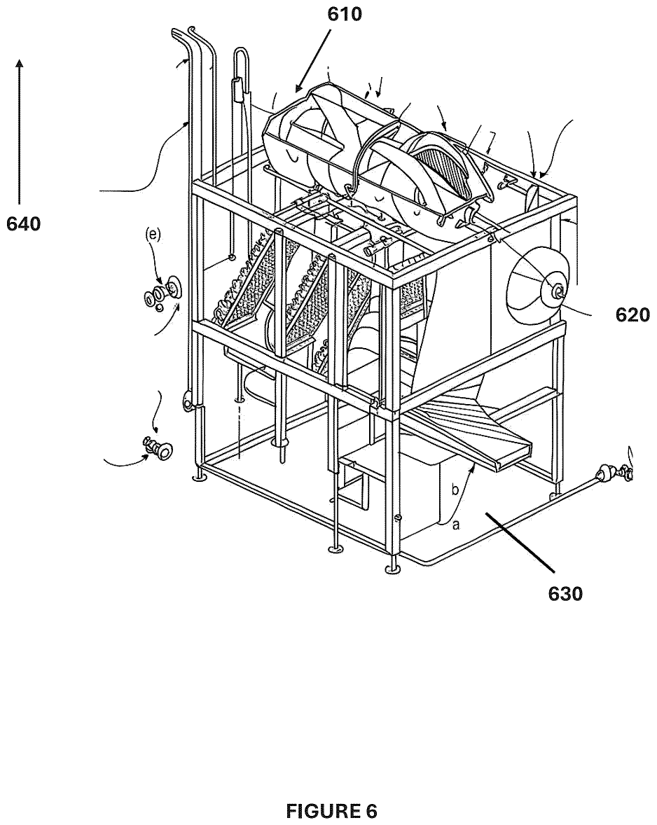

FIG. 6 shows the recycling system components designed for material recovery and regeneration processes within the catalytic converter system. This system facilitates the sustainable reuse of materials and supports the regeneration of active components, thereby enhancing the environmental and economic viability of the catalytic converter.

The mechanical separation mechanisms 620 are configured to disassemble the spent catalytic converter into constituent components. These mechanisms employ physical processes such as cutting, grinding, or sorting to separate the catalyst layers, support materials, and housing elements. The mechanical separation mechanisms are designed to operate with precision, ensuring minimal damage to recoverable materials and facilitating downstream processing.

The material recovery zones 630 are designated areas within the recycling system where separated components undergo further processing to extract materials of interest. These zones may include hydrometallurgical or pyrometallurgical setups for recovering active metals such as nickel, copper, iron, cobalt, and chromium. The material recovery zones are optimized to achieve high recovery efficiency while minimizing chemical waste generation and energy consumption.

The regeneration process flow 640 represents the sequence of operations for restoring the functionality of catalyst materials. This process includes controlled oxidation-reduction cycles, surface reconstruction mechanisms, and the removal of contaminants or poisons that may have accumulated during the catalytic converter's operational lifespan. The Oxide phase preparation may include precursor solution concentrations between 0.1 and 0.5M; a pH control range of 8.5-9.5; and a calcination temperature of 450-550° C. The regeneration process flow is designed to reactivate the catalytic properties of the recovered materials, enabling their reuse in new or refurbished catalytic converters.

The component recovery paths 610 are integrated pathways that guide the movement of separated materials through the recycling system. These paths ensure the systematic transfer of components from the mechanical separation mechanisms to the material recovery zones and subsequently to the regeneration process flow. The component recovery paths are designed to minimize cross-contamination and optimize the efficiency of the recycling operations.

This recycling system plays a significant role in the sustainable design, facilitating the recovery and reuse of materials while mitigating the environmental impact linked to the disposal of spent catalytic converters. The disclosed system serves as a basis for future developments in recycling methodologies and contributes to the overarching objective of sustainable exhaust gas treatment technologies.

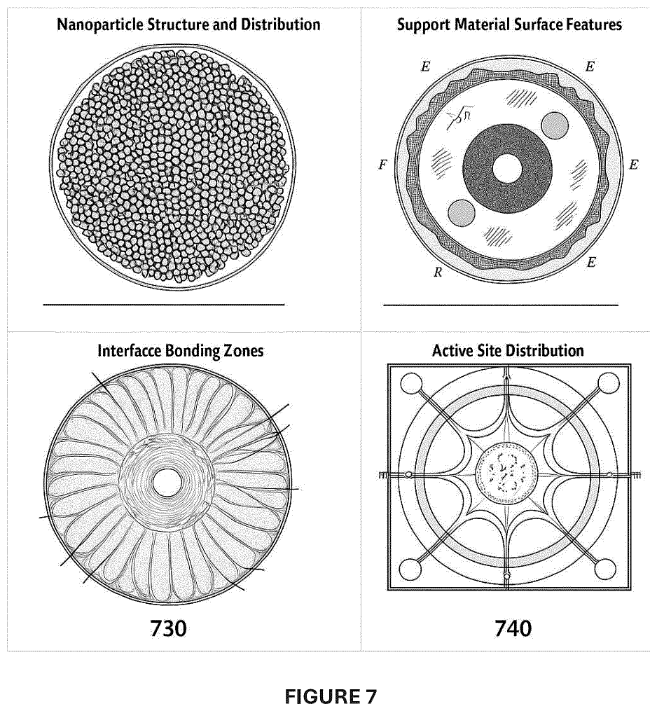

FIG. 7 shows the material optimization details relevant to the disclosed subject matter, illustrating the structural and functional aspects of the catalyst materials used in the multi-phase catalyst system.

The nanoparticle structure and distribution 710 illustrate the arrangement of nickel-copper alloy nanoparticles within the primary catalyst phase. These nanoparticles are characterized by a uniform size distribution, ranging from 10-50 nm, which plays a significant role in increasing the surface area and maintaining consistent catalytic activity. The uniform dispersion of nanoparticles reduces aggregation and facilitates effective interaction with exhaust gases, thereby improving the reduction of nitrous oxide emissions. The tailored particle size and distribution support the catalytic efficiency and stability of the primary phase.

The support material surface features 720 illustrate the modified surface characteristics of the support materials, such as alumina, silicon carbide, and titanium dioxide, used across the catalyst phases. The surface features include a high density of micropores and mesopores, which facilitate gas diffusion and provide access to active sites. The surface modifications, such as thermal activation and chemical treatments, enhance the compatibility between the support materials and the active catalyst components. These features ensure robust adhesion of nanoparticles and promote uniform distribution of catalytic sites, thereby improving the overall performance and durability of the catalyst structure.

The interface bonding zones 730 highlight the regions where distinct catalyst phases interact within the multi-phase structure. These zones are designed to optimize the transfer of reactants and intermediates between the primary, secondary, and tertiary phases. The bonding zones feature enhanced structural integrity and minimized resistance to gas flow, ensuring seamless interaction between the phases. This configuration supports efficient catalytic reactions across the entire structure and contributes to the high nitrous oxide reduction efficiency of the system.

The active site distribution 740 provides a schematic representation of the spatial arrangement of catalytic active sites within the multi-phase catalyst structure. The distribution is optimized to ensure uniform accessibility of exhaust gases to the active sites, thereby maximizing the catalytic activity. The arrangement of active sites is tailored to the specific requirements of each phase, with nickel-copper alloy nanoparticles in the primary phase, iron-chromium oxide spinels in the secondary phase, and copper-cobalt mixed oxides in the tertiary phase. This strategic distribution enhances the interaction between the exhaust gases and the catalyst materials, ensuring thorough reduction of nitrous oxide emissions.

Overall, FIG. 7 illustrates the significant design elements of the catalyst materials, including nanoparticle distribution 710, support surface features 720, interface bonding zones 730, and active site arrangement 740, which collectively contribute to the high efficiency, durability, and sustainability of the multi-phase catalyst system.

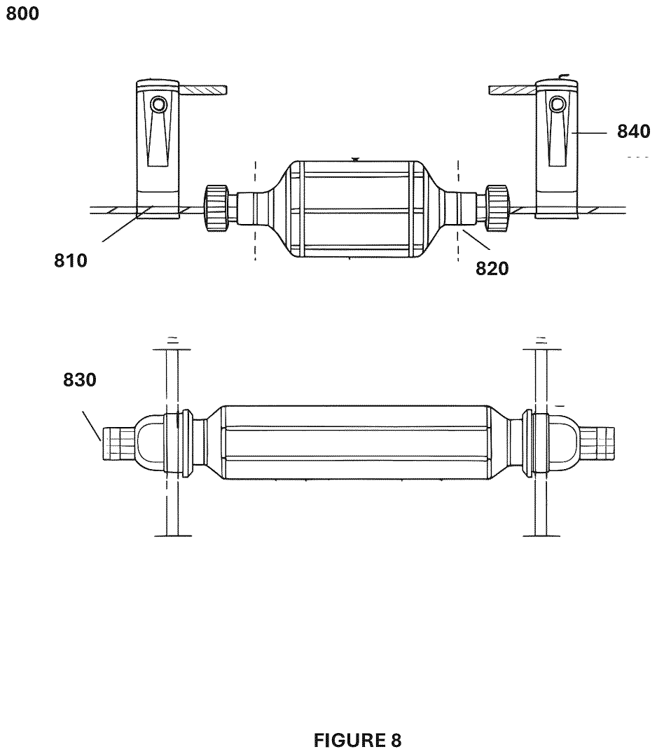

FIG. 8 shows the integration specifications for the universal mounting system 800 used in the catalytic converter. This figure illustrates the components and features that enable seamless installation, compatibility, and maintenance of the catalytic converter within various exhaust system configurations.

The universal mounting system 800 is designed to provide structural support and adaptability for integration with a wide range of vehicle exhaust systems. This system incorporates adjustable bracket configurations that ensure secure attachment to the vehicle chassis while accommodating variations in exhaust system dimensions. The mounting system is engineered to maintain the integrity of the catalytic converter during operation, including under conditions of vibration and thermal expansion.

The maintenance access points 810 are strategically positioned to facilitate routine inspections, servicing, and replacement of the catalytic converter. These access points are designed to allow easy removal and reinstallation of the converter without requiring extensive disassembly of the surrounding exhaust system components. This feature significantly reduces maintenance time and enhances the practicality of the system for end users.

The sensor integration points 820 are included to support the installation of sensors for monitoring operational parameters such as temperature, pressure, and gas composition. These integration points are configured to ensure proper alignment and secure attachment of sensors, enabling accurate data collection and real-time feedback to the vehicle's control systems. The placement of these points is optimized to improve the performance and diagnostic capabilities of the catalytic converter.

The connection interface 830 is designed to provide a standardized coupling mechanism between the catalytic converter and the exhaust system. This interface ensures a tight seal to prevent gas leakage and supports efficient gas flow through the converter. The connection interface is compatible with industry-standard dimensions and includes features such as gaskets or clamps to enhance durability and ease of installation.

The exhaust system compatibility 840 is a significant aspect of the universal mounting system, facilitating the integration of the catalytic converter with a range of exhaust system designs. This compatibility is achieved through adjustable mounting brackets and flexible connection interfaces that accommodate different pipe diameters, orientations, and configurations. The design emphasizes adaptability to enhance the applicability of the catalytic converter across various vehicle models and types.

Overall, FIG. 8 highlights the thoughtful design and engineering of the universal mounting system 800, emphasizing the adaptability, ease of maintenance, and integration capabilities of the system. These features collectively enhance the functionality and user-friendliness of the catalytic converter system.

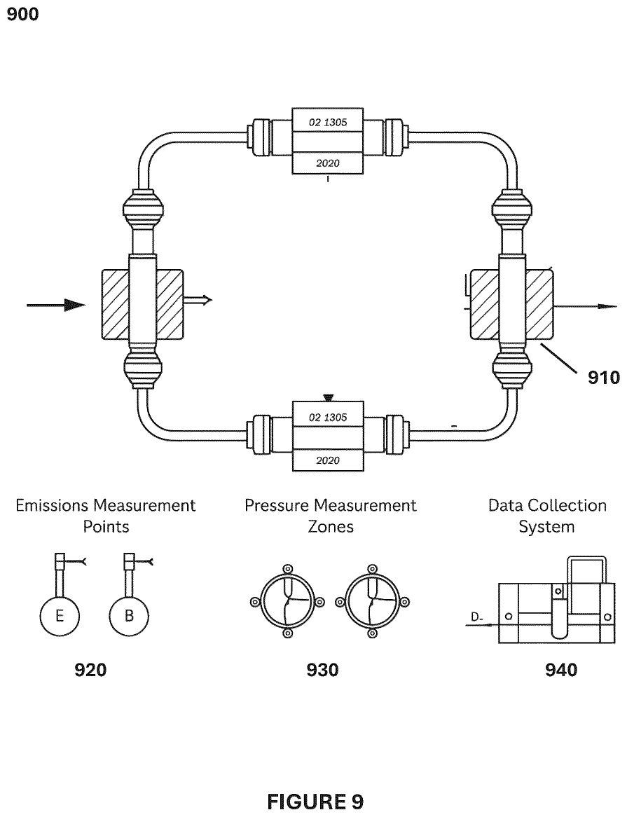

FIG. 9 shows the performance testing setup for evaluating the operational efficiency and functionality of the catalytic converter system. This setup is designed to measure important parameters such as emissions, temperature, pressure, and flow rate, while collecting data for analysis and optimization.

The emissions measurement points 920 are strategically positioned within the testing setup to monitor the concentration of nitrous oxide (N₂O) and other exhaust gases before and after passing through the catalytic converter. These points are equipped with sensors capable of detecting and quantifying gas compositions, providing real-time data on the reduction efficiency of the catalytic converter. The placement of these measurement points ensures accurate assessment of the system's ability to mitigate harmful emissions.

The flow rate measurement setup 900 is integrated into the testing system to evaluate the velocity and volume of exhaust gases passing through the catalytic converter. This setup includes flow sensors configured to measure the rate of gas flow under varying operating conditions, such as idle, city driving, and highway driving. The flow rate data is critical for understanding the interaction between exhaust gases and the catalyst structure, as well as for optimizing the gas flow distribution within the system.

The pressure measurement zones 930 are incorporated to monitor pressure levels at different points within the testing setup. These zones are equipped with pressure sensors designed to detect variations in pressure caused by the catalytic reactions and flow dynamics. The data collected from these zones helps identify potential pressure drops or irregularities that could impact the efficiency of the catalytic converter. Maintaining consistent pressure levels is necessary for achieving uniform gas flow and effective catalytic performance.

The temperature monitoring location 910 is positioned to track the thermal conditions within the testing setup. This location includes temperature sensors capable of providing real-time data on the operating temperature of the catalytic converter. The temperature data is used to evaluate the effectiveness of the thermal management system and to ensure that the catalyst structure operates within the appropriate temperature range. Maintaining a uniform temperature distribution is necessary for sustaining catalytic activity and preventing thermal damage.

The data collection system 940 serves as the central hub for aggregating and analyzing the data obtained from the emissions measurement points 920, flow rate measurement setup 900, pressure measurement zones 930, and temperature monitoring location 910. This system is equipped with advanced data processing capabilities to generate comprehensive reports on the performance metrics of the catalytic converter. The collected data is used to validate the reduction efficiency, durability, and overall functionality of the system under various testing conditions.

This performance testing setup provides a robust framework for evaluating the catalytic converter system, ensuring that the system meets the desired specifications for nitrous oxide reduction, thermal management, and gas flow optimization. The integration of measurement points and data collection components allows for detailed analysis and supports further refinement of the design and operation of the catalytic converter system.

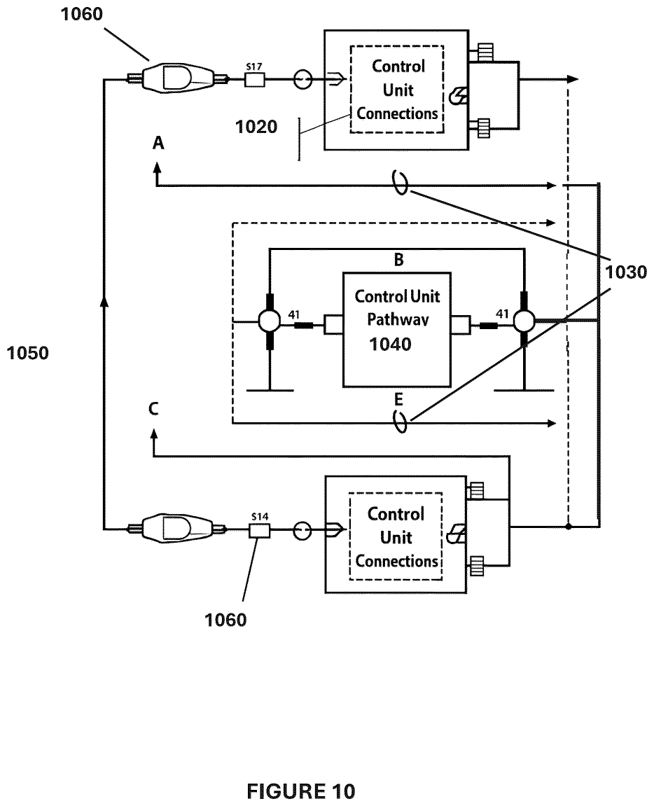

FIG. 10 shows the control system integration for the catalytic converter system, illustrating the arrangement and interaction of components designed to monitor, manage, and optimize the system's performance. The figure highlights the integration of emergency override systems 1010, sensor placement 1060, control unit connections 1020, diagnostic interface points 1030, control unit pathway 1040, and feedback loop pathway 1050.

The emergency override systems 1010 are configured to activate under predefined conditions, such as system malfunctions or significant operational thresholds. These systems enhance the safety and reliability of the catalytic converter by providing immediate corrective actions to prevent damage or failure. The emergency override systems are integrated with the control unit connections 1020 to enable seamless communication and execution of override protocols.

The sensor placement 1060 is strategically distributed throughout the control system to collect real-time data on various operational parameters, including temperature, pressure, and gas composition. These sensors play a significant role in monitoring the performance of the catalytic converter and providing input to the control unit connections 1020. The placement of sensors is optimized to ensure accurate data collection and thorough coverage of the system's important areas.

The control unit connections 1020 serve as the central hub for processing data received from the sensors and executing commands based on the system's operational requirements. These connections facilitate communication between the sensors, feedback loop pathway 1050, and diagnostic interface points 1030, ensuring coordinated functionality across the control system.

The diagnostic interface points 1030 are integrated into the control system to enable troubleshooting, performance analysis, and system calibration. These points provide access to diagnostic data, allowing operators to identify and address issues efficiently. The diagnostic interface points are designed to support compatibility with standard diagnostic tools and protocols, enhancing the system's maintainability.

The control unit pathway 1040 represents the logical and physical routes through which data and commands are transmitted within the control system. This pathway ensures the efficient flow of information between the control unit connections 1020, feedback loop pathway 1050, and emergency override systems 1010. The pathway is designed to minimize latency and maximize the responsiveness of the control system.

The feedback loop pathway 1050 is an integral part of the control system, enabling dynamic adjustments based on real-time data. This pathway facilitates the ongoing monitoring and regulation of the catalytic converter's performance, promoting effective operation under varying conditions. The feedback loop pathway interacts with the control unit connections 1020 and emergency override systems 1010 to support system stability and efficiency.

Overall, FIG. 10 illustrates a sophisticated control system integration that combines sensor placement, diagnostic capabilities, and feedback mechanisms to enhance the functionality and reliability of the catalytic converter system. The design prioritizes real-time monitoring, safety, and adaptability, ensuring effective management of the system's operations.

The catalytic converter device may have an expected lifespan of over 120,000 miles. Those having ordinary skill in the art will recognize that the reduction of N₂O production, along with the recycling capabilities of the components, will significantly impact global warming reduction.

I claim:

1. A multi-phase catalyst structure for reducing nitrous oxide emissions in an exhaust stream, comprising:
a primary catalyst phase, including:
nickel-copper alloy nanoparticles having a particle size of 10-50 nm, a Ni: Cu ratio of 3:1 to 4:1, and supported on modified alumina with a surface area of 150-200 m²/g; and
a manganese oxide promoter distributed within the primary catalyst phase to enhance catalytic activity;
a secondary catalyst phase, including:
iron-chromium oxide spinel particles supported on silicon carbide with a pore volume of 0.6-0.8 cm³/g; and
a zinc oxide modifier integrated into the secondary catalyst phase to improve stability and performance;
a tertiary catalyst phase, including:
copper-cobalt mixed oxides supported on titanium dioxide with a pore size distribution of 2-50 nm; and
a magnesium oxide stabilizer incorporated into the tertiary catalyst phase to enhance thermal durability;
interface regions between the primary, secondary, and tertiary catalyst phases, configured to optimize gas flow and promote interaction between the phases;
a pore structure distributed across the multi-phase catalyst structure, comprising micropores and mesopores to facilitate efficient gas diffusion and catalytic reactions;
wherein the multi-phase catalyst structure is designed to achieve a nitrous oxide reduction efficiency of at least 90% under optimal operating conditions and is constructed from sustainable and readily available materials.

2. The multi-phase catalyst structure of claim 1, wherein the nickel-copper alloy nanoparticles have a particle size in a range of 10-30 nm.

3. The multi-phase catalyst structure of claim 1, wherein a nickel-to-copper ratio of the nickel-copper alloy nanoparticles is 3.5:1.

4. The multi-phase catalyst structure of claim 1, wherein:
the copper-cobalt mixed oxides of the tertiary catalyst phase are uniformly dispersed on the titanium dioxide support; and
the magnesium oxide stabilizer is present in an amount sufficient to enhance thermal durability at temperatures up to 900° C.

5. The multi-phase catalyst structure of claim 1, further comprising:
an interfacial bonding layer formed between at least two of the primary, secondary, and tertiary catalyst phases to enhance phase interactions.

6. The multi-phase catalyst structure of claim 1, wherein the pore structure comprises: a micropore volume of 0.2-0.4 cm³/g; and
a mesopore volume of 0.4-0.6 cm³/g to facilitate enhanced gas diffusion and catalytic reactions.

7. The multi-phase catalyst structure of claim 1, wherein:
the sustainable and readily available materials include alumina, silicon carbide, and titanium dioxide; and
the catalyst structure is further integrated onto a substrate selected from the group consisting of cordierite, stainless steel, and silicon carbide.

8. An apparatus for optimizing exhaust gas flow in a catalytic converter system, comprising:
a housing defining an interior chamber with an inlet and an outlet; and
a smart flow architecture integrated within the housing, the smart flow architecture comprising:
a flow distributor positioned at the inlet, configured to evenly distribute incoming exhaust gases across the interior chamber;
a plurality of optimized flow channels within the interior chamber, each channel having a geometry designed to promote turbulence and enhance gas mixing;
pressure equalization zones strategically positioned within the flow channels to minimize pressure drop and ensure uniform gas flow;
turbulence generation zones configured to increase interaction between exhaust gases and catalytic surfaces;
a flow optimizer positioned at the outlet, configured to streamline exhaust gas discharge while maintaining backpressure within acceptable limits; and
a mounting assembly operatively connected to the housing, enabling universal installation with existing exhaust systems;
wherein the smart flow architecture is adapted to enhance efficiency of catalytic reactions by optimizing gas flow distribution, reducing pressure drop, and promoting uniform interaction between exhaust gases and catalyst surfaces.

9. The apparatus of claim 8, wherein the flow distributor comprises:
a plurality of radially arranged vanes, configured to evenly distribute incoming exhaust gases across the interior chamber.

10. The apparatus of claim 8, wherein the plurality of optimized flow channels comprise:
curved or serpentine geometries, configured to enhance turbulence and promote gas mixing.

11. The apparatus of claim 8, wherein the pressure equalization zones further comprise:
integrated baffles, configured to reduce pressure drop within the interior chamber.

12. The apparatus of claim 8, wherein the turbulence generation zones include:
fixed obstacles, arranged within the optimized flow channels to increase interaction between exhaust gases and catalytic surfaces.

13. The apparatus of claim 8, wherein the mounting assembly comprises:
adjustable brackets, configured to enable universal installation with existing exhaust systems.

14. The apparatus of claim 8, further comprising:
sensor integration points, disposed within the interior chamber for monitoring exhaust gas flow parameters.

15. A method for managing thermal conditions in a catalytic converter system, comprising:
performing a step of defining an interior chamber within a housing, the interior chamber being configured to accommodate a catalyst structure;
performing a step of integrating an advanced thermal management system with the housing, the advanced thermal management system comprising:
ensuring uniform temperature distribution across the catalyst structure by operating a heat distribution network;
monitoring real-time temperature data by positioning temperature monitoring points within the housing;
activating emergency cooling channels operatively connected to the housing during overheating conditions to prevent thermal damage;
optimizing heat transfer and maintaining stable operating temperatures by configuring thermal gradient zones;
minimizing heat loss and improving thermal efficiency by surrounding the housing with insulation layers; and
stabilizing temperature fluctuations by storing and releasing thermal energy through a phase-change material chamber integrated within the thermal management system;
wherein the method is adapted to operate the catalytic converter system within a temperature range of 150° C. to 900 °C., ensuring efficient catalytic reactions and prolonged durability of the catalyst structure under varying exhaust gas conditions.

16. The method of claim 15, wherein the heat distribution network comprises:
a plurality of heat exchanger fins; and
the heat exchanger fins are arranged to direct and diffuse heat uniformly across the catalyst structure.

17. The method of claim 15, wherein the temperature monitoring points are positioned:
at predetermined intervals within the interior chamber; and
to ensure precise real-time temperature data collection.

18. The method of claim 15,
wherein the emergency cooling channels are configured to automatically activate when the temperature exceeds a preset threshold;
wherein the thermal gradient zones include:
at least one region with a reduced cross-sectional area; and
the reduced cross-sectional area is configured to enhance convective heat transfer.

19. The method of claim 15, wherein the phase-change material chamber contains:
a salt hydrate composition;
the salt hydrate composition has a melting point between 200° C. and 300° C.; and
the salt hydrate composition is configured to facilitate efficient thermal energy storage and release.

20. The method of claim 18, further comprising:
integrating the advanced thermal management system with a control unit;
wherein the control unit is configured to dynamically adjust the operation of the emergency cooling channels based on the monitored temperature data.
